(19) United States
(12) Patent Application Publication
(10) Pub. No.: US 2014/0118163 A1
(43) Pub. Date: May 1, 2014

(54) DATA PROCESSING APPARATUS AND DATA PROCESSING METHOD THEREOF FOR USE IN POWER LINE COMMUNICATIONS

(71) Applicant: INSTITUTE FOR INFORMATION INDUSTRY, Taipei (TW)

(72) Inventors: Ping-Heng LI, Caotun Township (TW); Chih-Chiang HSIEH, Taipei City (TW); EMERY JOU, Taipei City (TW); Yen-Ting CHEN, Zhongli City (TW)

(73) Assignee: INSTITUTE FOR INFORMATION INDUSTRY, Taipei (TW)

(21) Appl. No.: 13/746,387

(22) Filed: Jan. 22, 2013

(30) Foreign Application Priority Data
Oct. 30, 2012 (TW) 101140197

(51) Int. Cl. H04B 3/54

(52) U.S. Cl. CPC H04B 3/54
USPC 340/870.02

(57) ABSTRACT

A data processing apparatus and a data processing method thereof for use in power line communications are provided. The data processing apparatus includes a first communication interface, a second communication interface, a storage, and a processor electrically connected to the first communication interface, the second communication interface and the storage. The first communication interface communicates with an electricity meter via a first power line and receives a first signal from the electricity meter, wherein the first signal comprises electricity meter data. The second communication interface communicates with a concentrator via a second power line. The processor estimates a first channel parameter of the second power line, and stores the electricity meter data to the storage if the processor determines that the first channel parameter is larger than a channel parameter threshold.

### PRIORITY

This application claims priority to Taiwan Patent Application No.: 101140197 filed on Oct. 30, 2012, which is hereby incorporated by reference in its entirety.

### FIELD

The present invention provides a data processing apparatus and a data processing method thereof for use in power line communications (PLCs). More particularly, the present invention provides a data processing apparatus and a data processing method thereof which are capable of transmitting electricity meter data according to a channel transmission status.

### BACKGROUND

The advanced metering infrastructure (AMI) is mainly comprised of smart meters, a communication system and a meter database management system (MDMS). The smart meters have many features such as supporting various electricity charge rates, providing users with energy and electricity information to guide the users to save electricity, and accelerating power-failure detection and restoration, so the conventional electricity meters are gradually replaced by the smart meters. In recent years, owing to numerous conveniences provided by the smart meters for the human beings and with the environmental protection tendency to save energy and reduce carbon emission, many countries are making great efforts to actively develop the AMI.

The AMI usually uses power line communications (PLCs) as a way of wired data transmission, with electricity meter data being transmitted by the smart meters to a concentrator at regular intervals and then transmitted by the concentrator to a server of a back-end system. However, under the architecture of the PLC system, it is often the case that the uplink transmission power and the downlink transmission power do not match each other, which leads to problems such as the poor transmission efficiency and the poor accuracy of the electricity meter data transmitted from the electricity meter to the concentrator. Specifically, the downlink transmission power is usually higher than the uplink transmission power; that is, the transmission power of a signal transmitted from the concentrator to an electricity meter is higher than the transmission power of a signal transmitted from the electricity meter to the concentrator.

In General, the aforesaid problems are solved by additionally providing a repeater in the PLC system and using a power amplifier of the repeater to increase the transmission power of the signal carrying the electricity meter data so as to enhance the anti-decaying capability of the PLCs. However, the conventional repeater transmits all signals at the same power (usually at the maximum power that can be amplified) no matter whether the received signals have a high or low decay extent, and this tends to cause additional energy waste.

Furthermore, the conventional repeater transmits the electricity meter data to the concentrator and further to the server of the back-end system no matter whether the back-end channel conditions at that time are suitable for communication. Therefore, even when the back-end channel conditions are obviously unsuitable for communication, the conventional repeater still sends the electricity meter data out, which makes it impossible for the concentrator to accurately receive the electricity meter data; and because the repeater will not transmit the electricity meter data again, it is very likely that the electricity meter data will get lost. Meanwhile, the concentrator will repeatedly transmit a request signal when it fails to receive the electricity meter data, which will increase the load of the overall PLC system.

In view of this, an urgent need exists in the art to solve the problems such as the poor transmission efficiency and the poor accuracy of the electricity meter data transmitted from the electricity meter to the concentrator.

### SUMMARY

A primary objective of the present invention is to provide a data processing apparatus and a data processing method thereof for use in power line communications (PLCs). The data processing apparatus of the present invention can be installed between a concentrator and an electricity meter of any PLC system, and is configured to estimate a channel parameter of a transmission medium (i.e., a power line) between the concentrator and the electricity meter and to determine whether the power line between the electricity meter and the concentrator is suitable for transmitting electricity meter data according to the channel parameter. When it is determined that the power line between the electricity meter and the concentrator is unsuitable for transmitting the electricity meter data, the electricity meter data is temporarily stored into a storage for a period of time until the power line between the electricity meter and the concentrator is suitable for use in transmitting the electricity meter data. Accordingly, as compared to the conventional PLC system, the data processing apparatus and the data processing method thereof of the present invention can determine whether to transmit the electricity meter data to the concentrator according to a channel transmission status. Thereby, the problems such as the poor transmission efficiency and the poor accuracy of the electricity meter data transmitted from the electricity meter to the concentrator can be improved effectively.

To achieve the aforesaid objective, certain embodiments of the present invention provide a data processing apparatus for use in power line communications (PLCs), which comprises a first communication interface, a second communication interface, a storage and a processor. The first communication interface is configured to communicate with an electricity meter via a first power line and to receive a first signal from the electricity meter, wherein the first signal comprises electricity meter data. The second communication interface is configured to communicate with a concentrator via a second power line. The processor is electrically connected to the first communication interface, the second communication interface and the storage and configured to execute the following operations: estimating a first channel parameter of the second power line; and storing the electricity meter data to the storage when it is determined that the first channel parameter is greater than a channel parameter threshold.

To achieve the aforesaid objective, certain embodiments of the present invention further disclose a data processing method for use in power line communications (PLCs). A data processing apparatus comprises a first communication interface, a second communication interface, a storage, and a processor electrically connected to the first communication interface, the second communication interface and the storage. The first communication interface communicates with an electricity meter via a first power line, and the second communication interface communicates with a concentrator via a second power line. The data processing method comprises the following steps of:

(a) enabling the first communication interface to receive a first signal from an electricity meter, wherein the first signal comprises electricity meter data;

(b) enabling the processor to estimate a first channel parameter of the second power line; and

(c) enabling the processor to store the electricity meter data to the storage when it is determined that the first channel parameter is greater than a channel parameter threshold.

The detailed technology and preferred embodiments implemented for the present invention are described in the following paragraphs accompanying the appended drawings for persons skilled in this field to well appreciate the features of the claimed invention.

### BRIEF DESCRIPTION OF THE DRAWINGS

FIG. 1 is a schematic view of a data processing system 1 according to a first embodiment of the present invention;

FIG. 2 is a schematic view of a data processing system 9 according to a second embodiment of the present invention; and

FIG. 3 is a flowchart diagram of a data processing method according to a third embodiment of the present invention.

### DETAILED DESCRIPTION

The present invention can be explained with reference to the following example embodiments thereof. However, these example embodiments are not intended to limit the present invention to any specific examples, environments, embodiments, applications or implementations described in these embodiments. Therefore, description of these example embodiments is only for the purpose of illustration rather than to limit the present invention. In the following embodiments and the attached drawings, elements not directly related to the present invention are omitted from depiction; and dimensional relationships among individual elements in the attached drawings are illustrated only for ease of understanding but not to limit the actual scale.

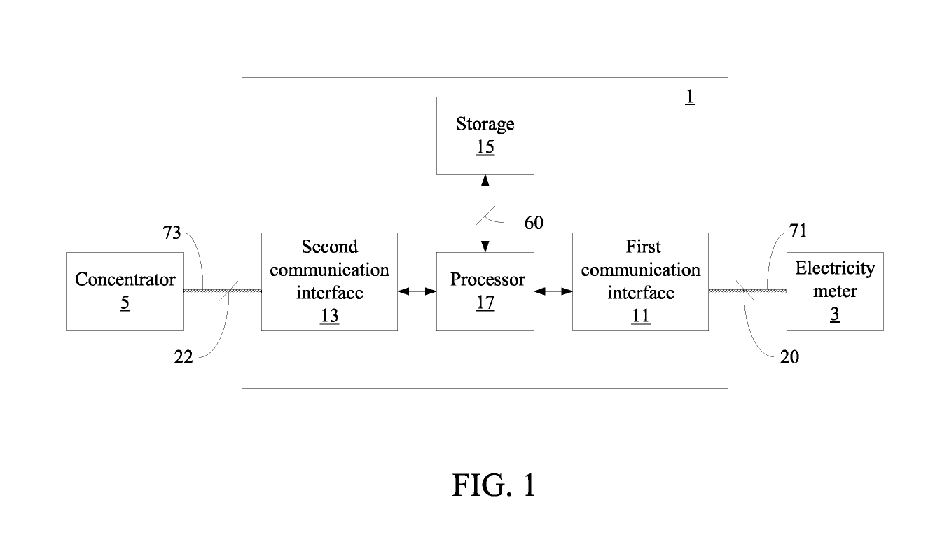

A first embodiment of the present invention is as shown in FIG. 1, which depicts a data processing apparatus 1 for use in power line communications (PLCs). The data processing apparatus 1 is disposed between an electricity meter 3 and a concentrator 5. The data processing apparatus 1 can be used in the architecture of the AMI. The electricity meter 3, which is a smart meter, is configured to receive an instruction from the concentrator 5 and to transmit data to the concentrator 5 according to the instruction. Moreover, the electricity meter 3 in nature has functions such as supporting various electricity charge rates, providing users with energy and electricity information to guide the users to save electricity, and accelerating power-failure detection and restoration. As a communication bridge between the electricity meter 3 and a server (not shown) of a back-end system, the concentrator 5 is configured to enable communication and data transmission between the electricity meter 3 and the server of the back-end system. Related operations of the electricity meter 3 and the concentrator 5 can be readily understood by those of ordinary skill in the art, so they will not be further described herein.

The data processing apparatus 1 comprises a first communication interface 11, a second communication interface 13, a storage 15 and a processor 17 which is electrically connected to the first communication interface 11, the second communication interface 13 and the storage 15. The first communication interface 11 communicates with the electricity meter 3 via a first power line 71 and receives a first signal 20 from the electricity meter 3. The first signal 20 comprises electricity meter data 60. The second communication interface 13 communicates with the concentrator 5 via a second power line 73. In other embodiments, the first communication interface 11 may communicate with a plurality of electricity meters via a first power line 71 and receive a plurality of pieces of electricity meter data from the electricity meters. Furthermore, operational relationships between the electricity meters and the data processing apparatus 1 as well as the concentrator 5 can be readily known according to the operations between the electricity meter 3 and the data processing apparatus 1 as well as the concentrator 5, so subsequent description will be made by taking only a single electricity meter (i.e., the electricity meter 3) as an example in this embodiment; however, this is not intended to limit the present invention.

The first communication interface 11 may comprise a first power line interface (not shown) and a first modulator (not shown). The first power line interface is configured to be compatible with the first power line 71 and can be used to receive data carried on the first power line 71; and the first modulator is configured to modulate the data carried on the first power line 71 into a data type that can be processed by the data processing apparatus 1. Similarly, the second communication interface 13 may comprise a second power line interface (not shown) and a second modulator (not shown). The second power line interface is configured to be compatible with the second power line 73 and can be used to transmit data to the second power line 73; and the second modulator is configured to modulate the data, which has been processed by the data processing apparatus 1, into a data type that can be carried on the second power line 73. The first power line interface may also have the function of transmitting data to the first power line 71, and the second power line interface may also have the function of receiving data from the second power line 73.

Optionally, after the first signal 20 is received by the first communication interface 11 from the electricity meter 3, the processor 17 may firstly determine whether a signal decay of the first signal 20 is smaller than (or no greater than) a signal decay threshold. The signal decay threshold may be set as different values or within different ranges by the designer according to different transmission conditions. If the processor 17 determines that the signal decay of the first signal 20 is smaller than (or no greater than) the signal decay threshold, it represents that the first power line 71 may currently have a poor channel status and the electricity meter data 60 carried in the first signal 20 received by the first communication interface 11 may be inaccurate. In this case, the processor 17 will not process the electricity meter data 60 currently received and directly removes the electricity meter data 60.

Optionally, after the first signal 20 is received by the first communication interface 11 from the electricity meter 3, the processor 17 may also firstly determine whether a bit error rate (BER) of the first signal 20 is smaller than (or no greater than) a BER threshold; or the processor 17 may firstly determine whether a signal decay of the first signal 20 is smaller than (or no greater than) a signal decay threshold and then determine whether a BER of the first signal 20 is smaller than (or no greater than) a BER threshold. The BER threshold may be set as different values or within different ranges by the designer according to different transmission conditions. If the processor 17 determines that the BER of the first signal 20 is smaller than (or no greater than) the BER threshold, it represents that the first power line 71 may currently have a poor channel status and the electricity meter data 60 carried in the first signal 20 received by the first communication interface 11 may be inaccurate. In this case, the processor 17 will not process the electricity meter data 60 currently received and directly removes the electricity meter data 60.

On the other hand, if the first power line 71 has a good channel status or, optionally, if the processor 17 determines that the signal decay of the first signal 20 is smaller than (or no greater than) the signal decay threshold and/or that the BER of the first signal 20 is smaller than (or no greater than) the BER threshold, then the processor 17 will further process the electricity meter data 60 carried in the first signal 20 according to a channel status of the second power line 73.

Furthermore, the processor 17 can estimate a first channel parameter 40 (not shown) of the second power line 73 according to different channel estimation technologies, and then determine whether the first channel parameter 40 is greater than (or no smaller than) a channel parameter threshold. The channel parameter threshold may be set as different values or within different ranges by the designer according to different transmission conditions. In this embodiment, the first channel parameter 40 of the second power line 73 may be a channel decay value of the second power line 73, and the channel parameter threshold is a channel decay threshold. However, the number and the type of the first channel parameter 40 and the channel parameter threshold are not intended to limit the present invention.

When the processor 17 determines that the first channel parameter 40 is greater than (or no smaller than) the channel parameter threshold, i.e., when the processor 17 determines that the channel decay value of the second power line 73 is greater than (or no smaller than) the channel decay threshold, the processor 17 ascertains that the second power line 73 is currently unsuitable for transmitting the electricity meter data 60. In this case, the processor 17 stores the electricity meter data 60 into the storage 15, and waits to transmit the electricity meter data 60 to the concentrator 5 when the second power line 73 becomes suitable for transmitting the electricity meter data 60.

The processor 17 can estimate a second channel parameter 42 of the second power line 73 again after a time interval. The time interval may be set as different values or within different ranges by the designer according to different transmission conditions. When the processor 17 determines that the second channel parameter 42 is smaller than the channel parameter threshold, i.e., when the processor 17 determines that the channel decay value of the second power line 73 is smaller than the channel decay threshold, the processor 17 ascertains that the second power line 73 currently becomes suitable for transmitting the electricity meter data 60. In this case, the processor 17 transmits a second signal 22 to the concentrator 5 via the second communication interface 13. The second signal 22 comprises the electricity meter data 60 stored in the storage 15. If the second channel parameter 42 is still greater than the channel parameter threshold at this time point, then the processor 17 will estimate a third channel parameter 44 of the second power line 73 again after another time interval and repeat the aforesaid operations. The time intervals for which the processor 17 waits may be identical to or different from each other.

In this embodiment, the channel decay threshold may also be represented as an average channel decay threshold or a channel decay threshold of any frequency band. For example, the processor 17 may estimate an average channel decay value of the second power line 73 and determine whether the average channel decay value is greater than (or no smaller than) the average channel decay threshold (e.g., 40 dB) so as to estimate the channel status of the second power line 73. The processor 17 may also estimate a channel decay value of any frequency band of the second power line 73 and determine whether the channel decay value of the frequency band is greater than (or no smaller than) the channel decay threshold (e.g., 60 dB) of the frequency band so as to estimate the channel status of the second power line 73. The above examples related to the channel decay threshold are only provided for ease of description but are not intended to limit the present invention.

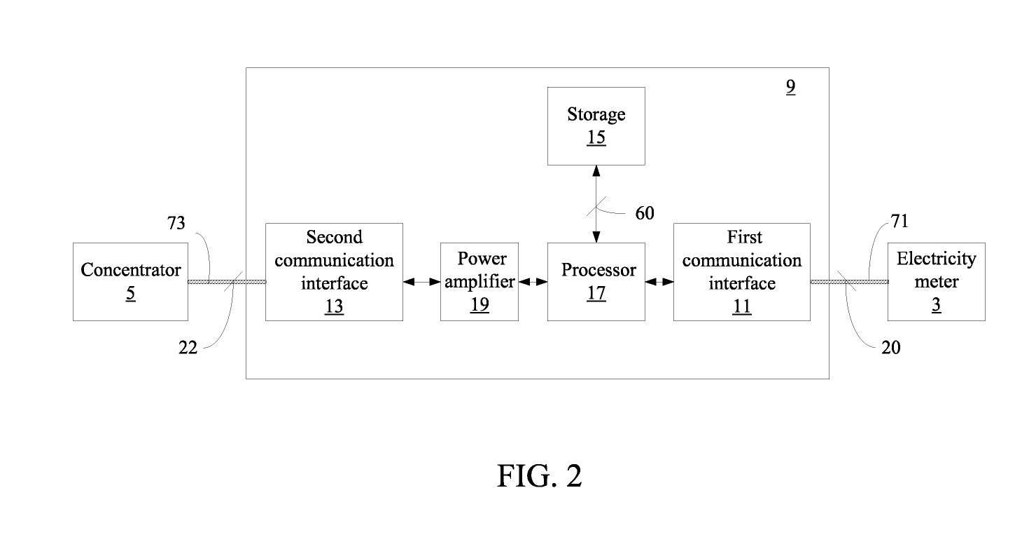

A second embodiment of the present invention is as shown in FIG. 2, which depicts a data processing apparatus 9 for use in power line communications (PLCs). Except components that are specially described in this embodiment, the other components can all be understood as the corresponding components in the aforesaid embodiment; and reference numerals of some of the components described in the aforesaid embodiment will still be used in this embodiment to represent substantially the same or similar components. For technical contents related to the aforesaid embodiment, they can be readily known according to the aforesaid embodiment and, thus, will not be further described in this embodiment.

As shown in FIG. 2, the data processing apparatus 9 comprises a first communication interface 11, a second communication interface 13, a storage 15, a processor 17 and a power amplifier 19. Different from the data processing apparatus 1 of the first embodiment, the data processing apparatus 9 of this embodiment further comprises the power amplifier 19, which is electrically connected to the processor 17 and the second communication interface 13. In other embodiments, the power amplifier 19 may also be built in the second communication interface 13 and electrically connected to the processor 17.

As described in the first embodiment, when the processor 17 determines that the second channel parameter 42 is smaller than the channel parameter threshold, i.e., when the processor 17 determines that the channel decay value of the second power line 73 is smaller than the channel decay threshold, the processor 17 transmits a second signal 22 to the concentrator 5 via the second communication interface 13. In this case, the power amplifier 19 can be used to amplify a transmission power of the second signal 22.

In this embodiment, the power amplifier 19 may be a fixed power amplifier or an adjustable power amplifier. When the power amplifier 19 is a fixed power amplifier, the power amplifier 19 uses a fixed amplification power to amplify the transmission power of the second signal 22. However, when the power amplifier 19 is an adjustable power amplifier, the processor 17 can decide the transmission power of the second signal 22 according to the second channel parameter 42. In other words, the processor 17 can, according to the channel status of the second power line 73, control the power amplifier 19 to amplify the transmission power of the second signal 22 to different extents. In other words, when the power amplifier 19 is an adjustable power amplifier, the power amplifier 19 can adjust the extent to which the transmission power of the second signal 22 is amplified according to the second channel parameter 42 (e.g., the channel decay value) of the second power line 73 so as to avoid waste of the transmission power.

In addition to the aforesaid steps, the data processing apparatus 9 of this embodiment can also execute all the operations set forth in the first embodiment and have all the corresponding functions. The method in which the data processing apparatus 9 of this embodiment executes these operations and has these functions can be readily appreciated by those of ordinary skill in the art based on the explanation of the first embodiment, and thus will not be further described herein.

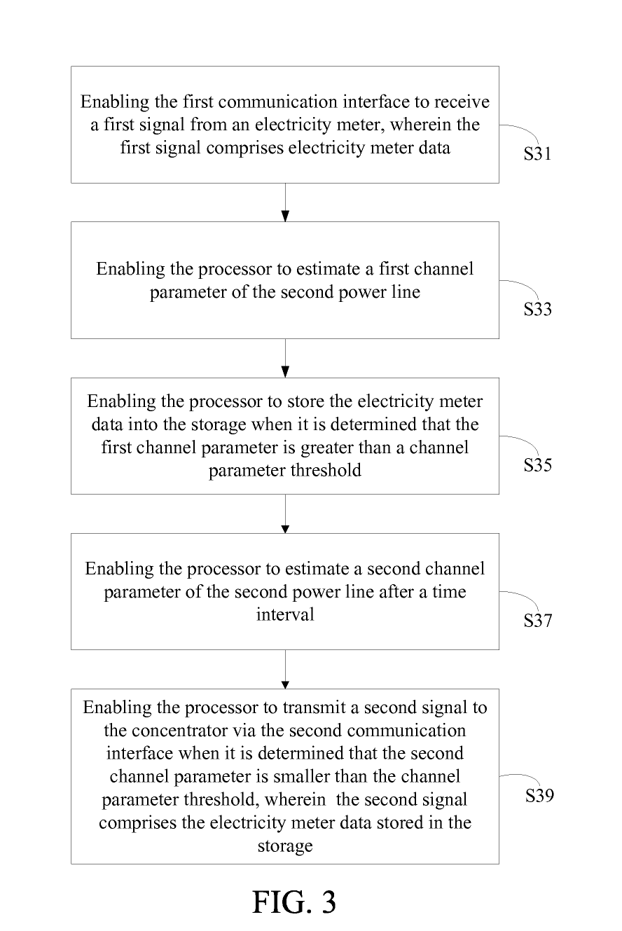

A third embodiment of the present invention is as shown in FIG. 3, which is a flowchart diagram of a data processing method for use in power line communications (PLCs). The data processing method of this embodiment can be used in a data processing apparatus (e.g., the data processing apparatus 1 of the first embodiment). Therefore, the data processing apparatus of this embodiment may comprise a first communication interface, a second communication interface, a storage and a processor which is electrically connected to the first communication interface, the second communication interface and the storage. The first communication interface communicates with an electricity meter via a first power line, and the second communication interface communicates with a concentrator via a second power line.

As shown in FIG. 3, step S31 is executed to enable the first communication interface to receive a first signal from an electricity meter. The first signal comprises electricity meter data. In other embodiments, the step S31 may comprise the following limitation conditions: a signal decay of the first signal is smaller than (or no greater than) a signal decay threshold and/or a BER of the first signal is smaller than (or no greater than) a BER threshold. Step S33 is executed to enable the processor to estimate a first channel parameter of the second power line. Step S35 is executed to enable the processor to store the electricity meter data into the storage when it is determined that the first channel parameter is greater than (or no smaller than) a channel parameter threshold.

After the step S35, the data processing method of this embodiment may further comprise the following steps: a step S37 is executed to enable the processor to estimate a second channel parameter of the second power line after a time interval; and a step S39 is executed to enable the processor to transmit a second signal to the concentrator via the second communication interface when it is determined that the second channel parameter is smaller than the channel parameter threshold. Here, the second signal comprises the electricity meter data stored in the storage. Each of the first channel parameter and the second channel parameter of this embodiment may be a channel decay value of the second power line, and the channel parameter threshold may be a channel decay threshold.

The data processing method of this embodiment may also be used in the data processing apparatus 9 of the second embodiment. In this case, the data processing apparatus of this embodiment further comprises a power amplifier electrically connected to the processor and the second communication interface. Then, the step S39 further comprises a step S391 (not shown) of enabling the power amplifier to amplify a transmission power of the second signal. In other embodiments, the power amplifier of this embodiment may be an adjustable power amplifier. In the latter case, the step S391 further comprises a step S393 (not shown) of enabling the processor to decide the transmission power of the second signal according to the second channel parameter.

In addition to the aforesaid steps, the data processing method of this embodiment can also execute all the operations set forth in the first embodiment and the second embodiment and have all the corresponding functions. How the data processing method of this embodiment executes these operations and has these functions can be readily appreciated by those of ordinary skill in the art based on the explanation of the first embodiment and the second embodiment, and thus will not be further described herein.

According to the above descriptions, the data processing apparatus of the present invention can be installed between a concentrator and an electricity meter of any PLC system, and is configured to estimate a channel parameter of a transmission medium (i.e., a power line) between the concentrator and the electricity meter and to determine whether the power line between the electricity meter and the concentrator is suitable for transmitting electricity meter data according to the channel parameter. When it is determined that the power line between the electricity meter and the concentrator is unsuitable for transmitting the electricity meter data, the electricity meter data is temporarily stored into a storage for a period of time until the power line between the electricity meter and the concentrator becomes suitable for transmitting the electricity meter data. Accordingly, as compared to the conventional PLC system, the data processing apparatus and the data processing method thereof of the present invention can determine whether to transmit the electricity meter data to the concentrator according to a channel transmission status. Thereby, the problems such as the poor transmission efficiency and the poor accuracy of the electricity meter data transmitted from the electricity meter to the concentrator can be improved effectively.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data processing apparatus for use in power line communications (PLCs), comprising:
a first communication interface, being configured to communicate with an electricity meter via a first power line and to receive a first signal from the electricity meter, wherein the first signal comprises electricity meter data;
a second communication interface, being configured to communicate with a concentrator via a second power line;
a storage; and
a processor, being electrically connected to the first communication interface, the second communication interface and the storage and configured to execute the following operations:
estimating a first channel parameter of the second power line; and
storing the electricity meter data to the storage when it is determined that the first channel parameter is greater than a channel parameter threshold.

2. The data processing apparatus as claimed in claim 1, wherein the processor is further configured to execute the following operations:
estimating a second channel parameter of the second power line after a time interval; and
transmitting a second signal to the concentrator via the second communication interface when it is determined that the second channel parameter is smaller than the channel parameter threshold, wherein the second signal comprises the electricity meter data stored in the storage.

3. The data processing apparatus as claimed in claim 2, wherein each of the first channel parameter and the second channel parameter is a channel decay value of the second power line, and the channel parameter threshold is a channel decay threshold.

4. The data processing apparatus as claimed in claim 2, further comprising a power amplifier, wherein the power amplifier is electrically connected to the processor and the second communication interface and is configured to amplify a transmission power of the second signal.

5. The data processing apparatus as claimed in claim 4, wherein the power amplifier is an adjustable power amplifier, and the processor is further configured to decide the transmission power of the second signal according to the second channel parameter.

6. The data processing apparatus as claimed in claim 1, wherein a signal decay of the first signal is smaller than a signal decay threshold.

7. The data processing apparatus as claimed in claim 4, wherein a bit error rate (BER) of the first signal is smaller than a BER threshold.

8. A data processing method for use in power line communications (PLCs), a data processing apparatus comprising a first communication interface, a second communication interface, a storage, and a processor electrically connected to the first communication interface, the second communication interface and the storage, the first communication interface communicating with an electricity meter via a first power line, and the second communication interface communicating with a concentrator via a second power line, the data processing method comprising the steps of:
(a) enabling the first communication interface to receive a first signal from an electricity meter, wherein the first signal comprises electricity meter data;
(b) enabling the processor to estimate a first channel parameter of the second power line; and
(c) enabling the processor to store the electricity meter data to the storage when it is determined that the first channel parameter is greater than a channel parameter threshold.

9. The data processing method as claimed in claim 8, further comprising the steps of:
(d) enabling the processor to estimate a second channel parameter of the second power line after a time interval; and
(e) enabling the processor to transmit a second signal to the concentrator via the second communication interface when it is determined that the second channel parameter is smaller than the channel parameter threshold, wherein the second signal comprises the electricity meter data stored in the storage.

10. The data processing method as claimed in claim 9, wherein each of the first channel parameter and the second channel parameter is a channel decay value of the second power line, and the channel parameter threshold is a channel decay threshold.

11. The data processing method as claimed in claim 9, wherein the data processing apparatus further comprises a power amplifier electrically connected to the processor and the second communication interface, the step (e) further comprising the step of:
(e1) enabling the power amplifier to amplify a transmission power of the second signal.

12. The data processing method as claimed in claim 11, wherein the power amplifier is an adjustable power amplifier, the step (e1) further comprising the step of:
(e2) enabling the processor to decide the transmission power of the second signal according to the second channel parameter.

13. The data processing method as claimed in claim 8, wherein a signal decay of the first signal is smaller than a signal decay threshold.

14. The data processing method as claimed in claim 13, wherein a bit error rate (BER) of the first signal is smaller than a BER threshold.
